(19) United States
(12) Patent Application Publication
(10) Pub. No.: US 2011/0246938 A1
(43) Pub. Date: Oct. 6, 2011

(54) ENHANCED METADATA PERSISTANT USER INTERFACE NAVIGATION

(75) Inventors: Naveed Anis Khawaja, Welwyn Garden City (GB); Maliha Naveed, Welwyn Garden City (GB); David Gray, Welwyn Garden City (GB)

(73) Assignee: XEROX CORPORATION, NORWALK, CT (US)

(21) Appl. No.: 12/754,822

(22) Filed: Apr. 6, 2010

(51) Int. Cl. G06F 3/048

(52) U.S. Cl. 715/810

(57) ABSTRACT

A method and apparatus receive a user login and first menu selections through a graphic user interface of a multi-function printing device. The method processes one or more first sheets through a document handler of the multi-function printing device by following the first menu selections. Once finished processing the first sheet (or set of sheets) through the document handler, the method can then receive different (second) menu selections from the user. Then, the method processes one or more second sheets through the document handler by following the second menu selections. In order to provide greater ease of use, the methods herein present the user with an option to revert back to any of the previous menu selections (e.g., the first menu selections) through the graphic user interface. If the user chooses to revert to the first menu selections, the methods herein can process one or more third sheets through the document handler of the multi-function printing device by following the first menu selections. Eventually the method will receive a user logout through the graphic user interface, and after the method receives the user logout, the method clears the settings relating to the first menu selections and the second menu selections.

### BACKGROUND AND SUMMARY

Embodiments herein generally relate to methods and systems applicable to graphic user interfaces of multi-function printing devices, and more particularly to methods, systems, and devices that provide the user options to toggle between different configurations established during a user logon session.

Multi-function printing devices continue to grow in sophistication and capabilities, which presents the user with many more options than they had in the past. Most such options are selected by the user through menus presented on the graphic user interfaces of multi-function printing devices. It is important to continue to improve the methods and systems that operate such graphic user interfaces so as to aid the user and simplified operations.

One exemplary method receives a user login and first menu selections through a graphic user interface of a multi-function printing device. Such menu selections can relate to duplexing options, print quantity options, print quality options, facsimile options, e-mail options, and saving options. The first menu selections can comprise, for example, an identification of at least one e-mail recipient or at least one facsimile recipient of the documents that will be scanned/copied. The method processes one or more first sheets through a document handler of the multi-function printing device by following the first menu selections.

Once finished processing the first sheet (or set of sheets) through the document handler, the method can then receive different (second) menu selections from the user. The second menu selections can comprise, for example, an identification of different e-mail recipients or facsimile recipients. Then, the method processes one or more second sheets through the document handler by following the second menu selections.

In order to provide greater ease of use, the methods herein present the user with an option to revert back to any of the previous menu selections (e.g., the first menu selections) through the graphic user interface of the multi-function printing device. In one example, the option to revert is presented in the form of a back arrow (and a forward arrow) on the graphic user interface of the multi-function printing device. If the user chooses to revert to the first menu selections, the methods herein can process one or more third sheets through the document handler of the multi-function printing device by following the first menu selections.

The methods herein temporarily maintain the first menu selections and the second menu selections within a computer readable storage medium of the multi-function printing device while the user is logged onto the multi-function printing device. While the settings within the first menu selections and the second menu selections are maintained until user logout, the scan data of the first and second sheets is cleared from the computer readable storage medium as soon as new instructions are received and/or new documents are placed in the document handler.

Eventually the method will receive a user logout through the graphic user interface, and after the method receives the user logout, the method clears the settings relating to the first menu selections and the second menu selections from memory.

While method embodiments are mentioned above, device embodiments are also disclosed herein. One such device embodiment comprises a multi-function printing apparatus that has a graphic user interface operatively connected to a processor. The graphic user interface receives the user login and first menu selections from the user.

A document handler is also operatively connected to the processor. The document handler processes at least one first sheet by following the first menu selections. The graphic user interface can also receive second menu selections from the user. Again, the second menu selections are different than the first menu selections. The document handler processes at least one second sheet by following the second menu selections.

The graphic user interface provides the user the option to revert to the first menu selections. If the user reverts to the first menu selections, the document handler processes at least one third sheet by following the first menu selections. After the graphic user interface receives the user logout, the processor clears settings relating to the first menu selections and the second menu selections. Again, the option to revert can be presented as a back arrow (and a forward arrow) on the graphic user interface.

The device embodiments also include a computer readable storage medium operatively connected to the processor. The computer readable storage medium maintains the first menu selections and the second menu selections while the user is logged onto the multi-function printing device. The processor clears scan data of the first sheet from the computer readable storage medium when the second menu selections are received.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a schematic diagram of a multi-function printing device according to embodiments herein;

FIG. 3 is a schematic diagram of screenshot provided by exemplary embodiments herein;

FIG. 4 is a schematic diagram of screenshot provided by exemplary embodiments herein; and

FIG. 5 is a schematic diagram of screenshot provided by exemplary embodiments herein.

### DETAILED DESCRIPTION

The embodiments herein remember the job parameters for all jobs that the user has run during the current login session. This allows the user to navigate back to any of those previous jobs and then run a new job with the same parameters. Navigation can be by back and forward arrows/buttons similar to those used in a web browser. With embodiments herein, a user can run multiple copy jobs, each with different parameters, and then navigate back to the first job and run another job using those parameters. The user may also make changes to the job parameters before running the job. To address security concerns, the embodiments herein purge the job information when the user ends the login session. The embodiments herein provide increased convenience in a variety of scenarios. For example, a user testing color-correction settings can easily navigate back to a previous group of settings.

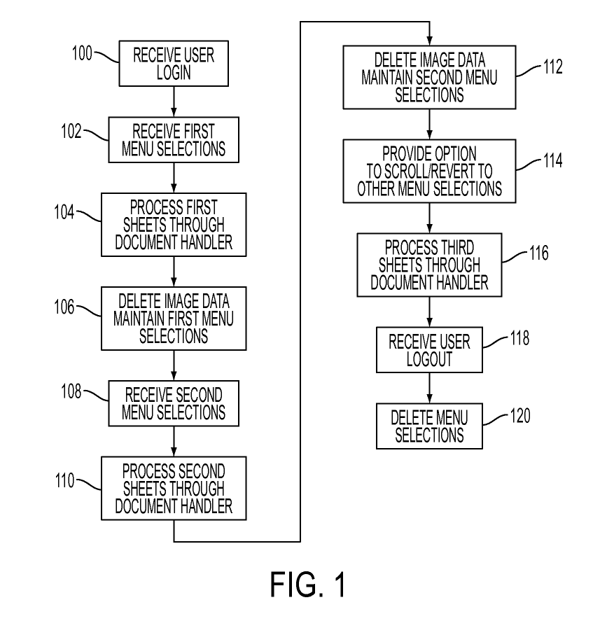

More specifically, as shown in flowchart form in FIG. 1, one exemplary method receives a user login (item 100) and first menu selections (item 102) through a graphic user interface of a multi-function printing device. Such menu selections can relate to duplexing options, print quantity options, print quality options, facsimile options, e-mail options, saving options, image capture from a camera device, etc. The first menu selections can comprise, for example, an identification of at least one e-mail recipient or at least one facsimile recipient of the documents that will be scanned/copied. The method processes one or more first sheets through a document handler of the multi-function printing device by following the first menu selections in item 104.

Once finished processing the first sheet (or set of sheets) through the document handler in item 104, the embodiments herein optionally delete the image data from the scanned first sheets, but maintain all information relating to the first menu selections as shown by item 106. The method can then receive different (second) menu selections from the user in item 108. The second sheets can be the same or different than the first sheets. The second menu selections can comprise, for example, an identification of different e-mail recipients or facsimile recipients. Then, the method processes one or more second sheets through the document handler by following the second menu selections in item 110.

Once finished processing the second sheet (or set of sheets) through the document handler in item 110, the embodiments herein delete the image data from the scanned second sheets, but maintain all information relating to the first menu selections and the second menu selections, as shown by item 112. While only two different copy/scan jobs are shown in the flowchart, those ordinarily skilled in the art would understand that many more jobs could be processed and many more menu selections can be maintained within the memory of the multi-function printing device. Therefore, 3, 5, 10, 20, etc., different menu selections could be maintained by the multi-function printing device with the embodiments herein depending upon how many different activities the user performed with the multi-function printing device during their current login session.

In order to provide greater ease of use, the methods herein present the user with an option to scroll through and revert back to any of the previous menu selections (e.g., the first menu selections) through the graphic user interface of the multi-function printing device in item 114. In one example, the option to revert is presented in the form of a back arrow/button (and a forward arrow/button) on the graphic user interface of the multi-function printing device. If the user chooses to revert to the first menu selections, the methods herein can process one or more third sheets through the document handler of the multi-function printing device by following the first menu selections in item 116.

The methods herein temporarily maintain the first menu selections and the second menu selections within a computer readable storage medium of the multi-function printing device while the user is logged onto the multi-function printing device as shown in items 112 and 114. While the settings within the first menu selections and the second menu selections are maintained until user logout, the scan data of the first and second sheets can be optionally cleared from the computer readable storage medium as soon as new instructions are received and/or new documents are placed in the document handler in items 112 and 114.

Eventually, the method will receive a user logout through the graphic user interface (item 118) and after the method receives the user logout, the method clears the settings relating to the first menu selections and the second menu selections in item 120.

Using an example to illustrate the foregoing, if a user wants to perform multiple activities while working at the machine, including copy, workflow scanning and fax, the user could go to the main screen on the graphic user interface of the multi-function printing device. The user would select the copy button, put originals on the document handler, and then select the quantity, tray etc. The user then presses the green button to start the scan. The scanning completes and the copy is produced in the output tray. The user would then return to the main screen, select the workflow scanning button and again put the (same or different) originals on the document handler. Next, the user would select the destination network folder/template, and presses the green button to start the scan. Once the scanning completes, the file goes to the target folder. Then, the user would again return to the main screen, select the fax button, and puts the (same or different) originals on the document handler. The user then selects the destination fax number (s), and presses the green button to start the scan. The scanning completes and the file faxing starts.

Some of the foregoing steps may be combined into a single process, depending upon the sophistication and options offered by the multi-function printing device. The embodiments herein build on the activity of the user by providing navigation buttons (forwards and backwards) for user control. This will keep track of all the session metadata while the user is within a specific login session. The embodiments herein keep the metadata alive during the navigation and thereby provide options to move to any previous configuration within the workflow procedure.

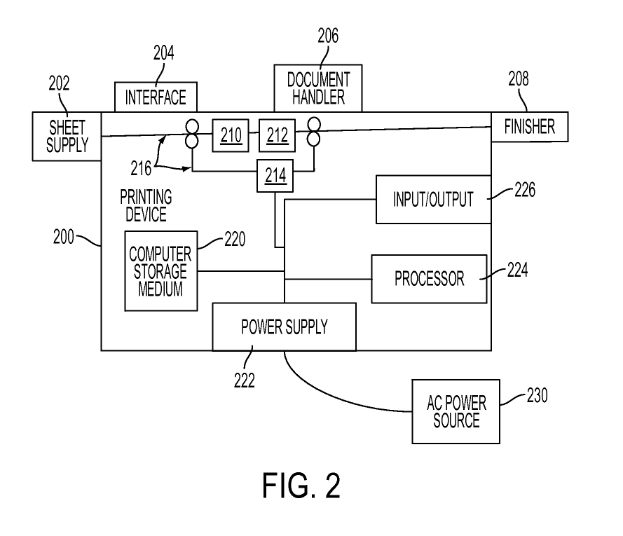

While method embodiments are mentioned above, device embodiments are also disclosed herein. One such device embodiment is shown in FIG. 2 and comprises a multi-function printing apparatus 200 that has a graphic user interface 204 operatively connected to a processor 224. The graphic user interface 204 receives the user login and first menu selections from the user.

A document handler 206 is also operatively connected to the processor 224. The document handler 206 includes a scanner and belts (and/or other media movement devices) that move the sheets by the scanner allowing images to be captured from the sheets and processed according to the menu selections.

In the multi-function printing device shown in FIG. 2, blank sheets of media are supplied from a sheet supply 202 along a paper path 216 to the various printing engines 210, 212, 214. After receiving various markings from the printing engines 210, 212, 214, the sheets of media pass to a finisher 208 which can fold, staple, sort, etc., the various printed sheets. An input/output device 226 is used for communications to and from the multi function printing device 200.

The processor 224 controls the various actions of the printing device 200. The power supply 222 connects to an external alternating current power source 230 and converts the external power into the type of power needed by the various devices mentioned above.

A computer readable storage medium 220 (which can be optical, magnetic, capacitor based, etc.) is readable by the processor 224 and stores instructions that the processor 224 executes to allow the multi-function printing device to perform its various functions. The computer readable storage medium 220 also temporarily stores the image data captured by the document handler 206 and the various menu selections input by the user into the graphic user interface 204. Thus, the computer readable storage medium maintains the first menu selections and the second menu selections while the user is logged onto the multi-function printing device. The processor 224 clears scan data of the previous sheets from the computer readable storage medium when subsequent menu selections are received.

Thus, the document handler 206 processes at least one first sheet by following the first menu selections. The graphic user interface 204 can also receive second menu selections from the user. Again, the second menu selections are different than the first menu selections. The document handler 206 processes at least one second sheet by following the second menu selections.

As mentioned above, because the embodiments herein maintain all previous menu selections that were made during the current login session in the computer readable storage medium 220, the graphic user interface 204 can provide the user the option of reverting to previous menu selections, such as the first menu selections. Again, the option to revert can be presented as a back arrow (and a forward arrow) on the graphic user interface 204. If the user reverts to the first menu selections, the document handler 206 processes at least one third sheet by following the first menu selections.

After the graphic user interface 204 receives the user logout, the processor 224 clears settings relating to the first menu selections and the second menu selections from the computer readable storage medium 220.

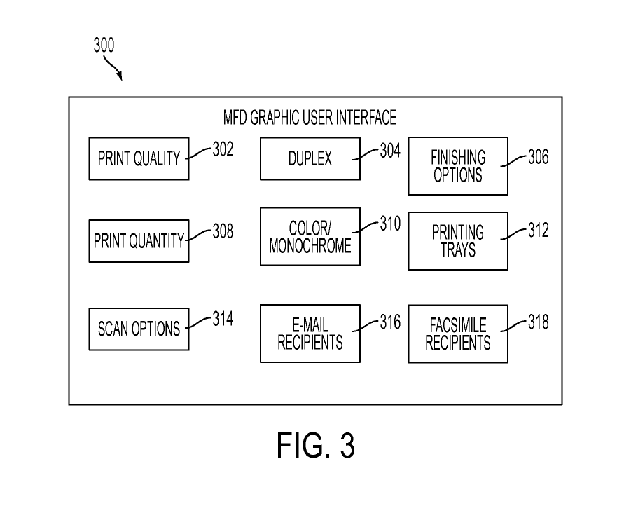

FIG. 3 illustrates an exemplary graphic user interface screenshot 300 displayed by the multi-function printing device that includes various menu options available to the user of the multi-function printing device. For example, various buttons are illustrated in the screenshot 300, the selection of which causes additional screens to be presented to the user to make various choices among the options. Exemplary screenshot 300 includes buttons for print quality 302, duplexing, 304, finishing options 306, print quantity 308, color options 310, printing tray options 312, scanning options 314, e-mail options 316, and facsimile options 318. While a limited number of menu topics are illustrated in FIG. 3, those ordinarily skilled in the art would understand that less options or many more options could be included, depending upon the capabilities of the multi-function printing device.

Thus, for example, if the duplex button 304 were selected from the screenshot 300, one or more additional screens would be presented to the user to determine whether duplexing is to be turned on, the type of duplexing to be utilized, etc. Similarly, if the e-mail button 316 were selected, one or more screens allowing for e-mail recipients to be added, types of emails to be selected, additional e-mail options, etc., would be presented to the user to allow the user to configure the job that will be processed by the document handler according to the user's desires.

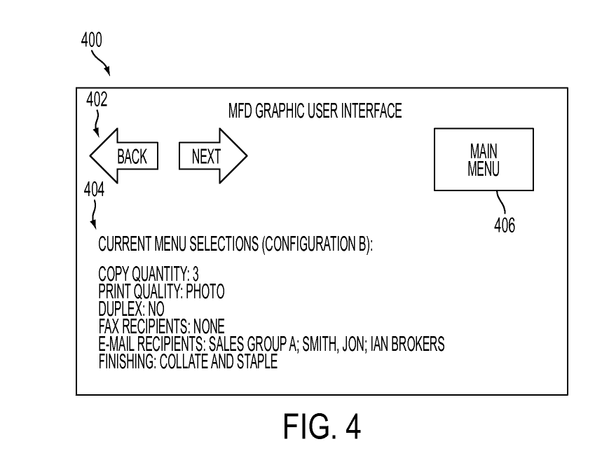

Once the user has made their various selections, the embodiments herein can display a summary of such selected options on the multi-function printing device graphic user interface, as illustrated by screenshot 400. More specifically, item 404 represents the various menu selections the user has made with respect to copy quantity, print quality, duplexing, fax recipients, etc. Again, depending upon the sophistication and options offered by the multi-function printing device, more menu selections or less menu selections may be illustrated in screenshot 400. For example, in less sophisticated devices, only the copy quantity and quality may be illustrated in the current menu selections 404; while, to the contrary, in more sophisticated devices, additional options such as workflows, etc., may be illustrated in addition to the menu selections illustrated in FIG. 4.

Further, screenshot 400 includes the main menu button 406 allowing the user to return to one of the previous menus (menus further up the menu hierarchy) such as screenshot 300 to allow the user to create one or more additional configuration (e.g., configuration C; configuration D; etc.).

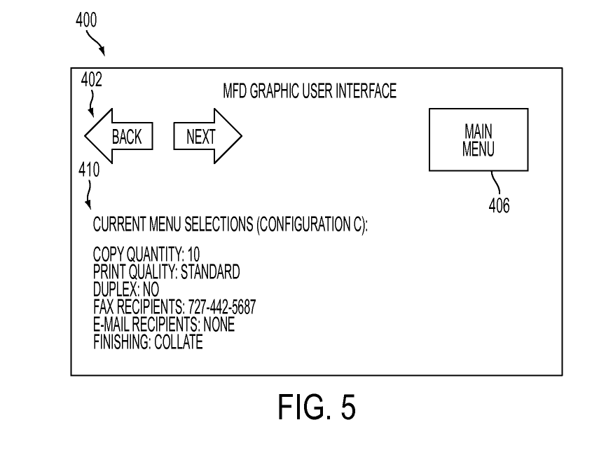

Note that in FIG. 4 the current menu selection is noted as configuration B, indicating that a previous configuration (configuration A) has already been made by the user during the current login session. Buttons/arrows 402 allow the user to toggle back and forth between the various previously chosen configurations of menu selections (at the same hierarchical level) that the user has made during the current login session. In other words, the user can press the back button to go back to configuration A and push the next button to go to configuration C 410, illustrated in FIG. 5.

Thus, the embodiments described above provide a navigation panel that tremendously improves the customer experience by allowing the user to navigate between screens that were recently used. The actual scanned content is not stored, however the settings, e.g., e-mail addresses and fax numbers, are maintained for further actions on the same recipients/settings. Having the forward and backward navigation option improves the customer experience.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
receiving a user login through a graphic user interface of a multi-function printing device;
receiving first menu selections from said user through said graphic user interface of said multi-function printing device;
processing at least one first sheet through a document handler of said multi-function printing device by following said first menu selections;
receiving second menu selections from said user through said graphic user interface of said multi-function printing device, said second menu selections being different than said first menu selections;
processing at least one second sheet through said document handler of said multi-function printing device by following said second menu selections;
providing said user an option to revert to said first menu selections through said graphic user interface of said multi-function printing device;
if said user reverts to said first menu selections, processing at least one third sheet through said document handler of said multi-function printing device by following said first menu selections;
receiving a user logout through said graphic user interface of said multi-function printing device; and
after receiving said user logout, clearing settings relating to said first menu selections and said second menu selections.

2. The method according to claim 1, said option to revert comprising presenting a back arrow and a forward arrow on said graphic user interface of said multi-function printing device.

3. The method according to claim 1, further comprising maintaining said first menu selections and said second menu selections within a computer readable storage medium of said multi-function printing device while said user is logged onto said multi-function printing device.

4. The method according to claim 1, further comprising clearing scan data of said first sheet from computer readable storage medium of said multi-function printing device when said second menu selections are received.

5. The method according to claim 1, said first menu selections and said second menu selections comprising menu selections of at least one of: duplexing options, print quantity options, print quality options, facsimile options, e-mail options, saving options, and images.

6. A method comprising:
receiving a user login through a graphic user interface of a multi-function printing device;
receiving first menu selections from said user through said graphic user interface of said multi-function printing device, said first menu selections comprising an identification of at least one e-mail recipient or at least one facsimile recipient;
processing at least one first sheet through a document handler of said multi-function printing device by following said first menu selections;
receiving second menu selections from said user through said graphic user interface of said multi-function printing device, said second menu selections comprising an identification of at least one e-mail recipient or at least one facsimile recipient, said second menu selections being different than said first menu selections;
processing at least one second sheet through said document handler of said multi-function printing device by following said second menu selections;
providing said user an option to revert to said first menu selections through said graphic user interface of said multi-function printing device;
if said user reverts to said first menu selections, processing at least one third sheet through said document handler of said multi-function printing device by following said first menu selections;
receiving a user logout through said graphic user interface of said multi-function printing device; and
after receiving said user logout, clearing settings relating to said first menu selections and said second menu selections.

7. The method according to claim 6, said option to revert comprising presenting a back arrow and a forward arrow on said graphic user interface of said multi-function printing device.

8. The method according to claim 6, further comprising maintaining said first menu selections and said second menu selections within a computer readable storage medium of said multi-function printing device while said user is logged onto said multi-function printing device.

9. The method according to claim 6, further comprising clearing scan data of said first sheet from computer readable storage medium of said multi-function printing device when said second menu selections are received.

10. The method according to claim 6, said first menu selections and said second menu selections comprising menu selections of at least one of: duplexing options, print quantity options, print quality options, facsimile options, e-mail options, saving options, and images.

11. A multi-function printing apparatus comprising:
a processor;
a graphic user interface operatively connected to said processor, said graphic user interface receiving a user login from a user, and first menu selections from said user;
a document handler operatively connected to said processor, said document handler processing at least one first sheet by following said first menu selections;
said graphic user interface receiving second menu selections from said user, said second menu selections being different than said first menu selections;
said document handler processing at least one second sheet by following said second menu selections;
said graphic user interface providing said user an option to revert to said first menu selections;
if said user reverts to said first menu selections, said document handler processing at least one third sheet by following said first menu selections;
said graphic user interface receiving a user logout; and
after receiving said user logout, said processor clearing settings relating to said first menu selections and said second menu selections.

12. The multi-function printing apparatus according to claim 11, said option to revert comprising presenting a back arrow and a forward arrow on said graphic user interface.

13. The multi-function printing apparatus according to claim 11, further comprising a computer readable storage medium operatively connected to said processor, said computer readable storage medium maintaining said first menu selections and said second menu selections while said user is logged onto said multi-function printing device.

14. The multi-function printing apparatus according to claim 11, further comprising a computer readable storage medium operatively connected to said processor, said processor clearing scan data of said first sheet from said computer readable storage medium when said second menu selections are received.

15. The multi-function printing apparatus according to claim 11, said first menu selections and said second menu selections comprising menu selections of at least one of: duplexing options, print quantity options, print quality options, facsimile options, e-mail options, saving options, and images.

16. The computer-readable storage medium maintaining a set of instructions executable by a computerized device, said set of instructions causing said computerized device to perform a method comprising:
receiving a user login through a graphic user interface of a multi-function printing device;
receiving first menu selections from said user through said graphic user interface of said multi-function printing device;
processing at least one first sheet through a document handler of said multi-function printing device by following said first menu selections;
receiving second menu selections from said user through said graphic user interface of said multi-function printing device, said second menu selections being different than said first menu selections;
processing at least one second sheet through said document handler of said multi-function printing device by following said second menu selections;
providing said user an option to revert to said first menu selections through said graphic user interface of said multi-function printing device;
if said user reverts to said first menu selections, processing at least one third sheet through said document handler of said multi-function printing device by following said first menu selections;
receiving a user logout through said graphic user interface of said multi-function printing device; and
after receiving said user logout, clearing settings relating to said first menu selections and said second menu selections.

17. The computer-readable storage medium according to claim 16, said option to revert comprising presenting a back arrow and a forward arrow on said graphic user interface of said multi-function printing device.

18. The computer-readable storage medium according to claim 16, said method further comprising maintaining said first menu selections and said second menu selections within a computer readable storage medium of said multi-function printing device while said user is logged onto said multi-function printing device.

19. The computer-readable storage medium according to claim 16, said method further comprising clearing scan data of said first sheet from computer readable storage medium of said multi-function printing device when said second menu selections are received.

20. The computer-readable storage medium according to claim 16, said first menu selections and said second menu selections comprising menu selections of at least one of: duplexing options, print quantity options, print quality options, facsimile options, e-mail options, saving options, and images.
